(19) United States
(12) Patent Application Publication
(10) Pub. No.: US 2009/0210926 A1
(43) Pub. Date: Aug. 20, 2009

(54) METHOD FOR MAINTAINING PLESIOCHRONOUS ENTITIES

(75) Inventor: Isaac J. Labaton, Macabim (IL)

Correspondence Address: SNELL & WILMER L.L.P. (Main), 400 EAST VAN BUREN, ONE ARIZONA CENTER, PHOENIX, AZ, 85004-2202, US

(73) Assignee: CIDWAY TECHNOLOGIES, LTD., London (GB)

(21) Appl. No.: 12/362,227

(22) Filed: Jan. 29, 2009

(30) Foreign Application Priority Data
Feb. 14, 2008 (IL) 189521

(51) Int. Cl. G06F 1/12; G06F 21/00

(52) U.S. Cl. 726/3; 713/400

(57) ABSTRACT

Methods and system are provided such that a Client device can send a synchronization signal to a Server device, and the Server can make the necessary adjustments to maintain the two devices plesiochronous. Further, the server is provided with the capabilities to calculate the Client time. That is, the server is configured to perform the necessary steps, as per the methods of this invention, in order to be able to compute the Client's CT^{Client} at any given opportunity. The system and methods that are provided allow the Server to distinguish between one particular client True-Client and a different entity pretending to be such client False-Client. The identification may be dynamic in order to avoid the possibility of impersonation of the True-Client by an eavesdropper.

### CROSS-REFERENCE TO RELATED APPLICATIONS

This application claims the right of priority based on Israeli Application No. 189521 entitled “A METHOD FOR MAINTAINING PLESIOCHRONOUS ENTITIES” filed on Feb. 14, 2008, which is incorporated herein by reference and assigned to the assignee herein.

### FIELD OF INVENTION

The present invention relates generally to maintaining the synchronization between two or more entities, and in particular to synchronizing a given entity, such as a server, which has an independent timepiece, with one or more entities, such as one or more clients, each of which also has an independent timepiece.

### BACKGROUND OF THE INVENTION

Event synchronization refers to a problem in timekeeping where the coordination of events is required to operate a system in unison.

Due to the fact that event synchronization is not exact, reference is made herein below to devices that are plesiochronous. The term plesiochronous is derived from the Greek plesio, meaning near, and chronos, meaning time. A plesiochronous system is a system that runs in a state where different parts of the system are almost, but not quite perfectly, synchronized.

Any device with a timepiece can determine the time at any given moment, which is referred to in the following as a Computed Time (CT). However, in the real word, there exist a drift between the Computed Time and the Exact Time.

That is, regular clocks such as clocks in devices (e.g., wristwatches, phones) usually drift compared to the actual Exact Time.

Therefore, one must often reset the device's time. Otherwise, the drift from the Exact Time becomes intolerable. Clocks often drift differently depending on the crystal quality (i.e., the quartz), the power the clock receives from the battery, the surrounding temperature, and other factors. Thus, the same clock can have different clock drift rates at different occasions.

Some clocks often have some kind of clock speed adjustment, whereby one can adjust the speed of the clock and thus correct the clock drift.

Mathematically, the DRIFT is a lack of exactitude expressed as the difference between the computed time (CT) and the Exact Time (ET) (i.e., the time computed by atomic clocks, which simple devices cannot afford to use).

DRIFT=CT−ET

There exists a clear need for synchronization between given entities, such as devices that each use an independent clock, whereby such synchronization or plesiochronization is referred to as the fulfilling of the following:

Assuming there are two devices: a CLIENT device and a SERVER device, each device with its independent clock; the two devices are synchronized up to a Tolerance (T), or more precisely, the two devices are plesiochronous, when, the following is satisfied. Define CT of the Client device=CT^{Client} and CT of the Server=CT^{server}, then the plesiochronous Tolerance T satisfies:

Tolerance T>Absolute Value [CT^{Client}−CT^{server}]=|CT^{Client}−CT^{server}|

Now, as stated above, DRIFT^{CLIENT}=CT^{Client}−ET and also, DRIFT^{server}=CT^{servert}−ET.

This implies that the client and server will be plesiochronized if:

Tolerance T>|CT^{Client}−CT^{server}|=|ET−DRIFT^{client}−ET+DRIFT^{server}|==|DRIFT^{server}−DRIFT^{client} |

This makes the plesiochronous characteristic an Exact Time independent attribute.

Further, given that the physical clock's DRIFT may be erratic and unpredictable in one example of a worse case scenario, where the absolute value of the DRIFT is increasing with the time:

For any event i: DRIFTᵢ=F(timeᵢ) where F is a function of the time and:

If time 1<time 2, then DRIFT₁=F(time₁)<DRIFT₂=F(time₂)

### SUMMARY OF THE INVENTION

In accordance with one embodiment of the present invention, the method and system presented herein below provides for a Client device that can send a synchronization signal to a Server device, and the Server can make the necessary adjustments to maintain the two devices plesiochronous. But more precisely, in accordance with an aspect of the method presented herein below, the server is provided with the capabilities to calculate the Client time. That is, the server is configured to perform the necessary steps, as per the method of this invention, in order to be able to compute the Client's CT^{Client} at any given opportunity.

Further, in accordance with an embodiment of the present invention, a system and methods are provided that allow the Server to distinguish between one particular client True-Client and a different entity pretending to be such client False-Client.

In accordance with this embodiment of the present invention, the identification may be dynamic in order to avoid the possibility of impersonation of the True-Client by an eavesdropper.

In accordance with another embodiment of the present invention, a system and methods are provided where the Server and Client select a given function of the time F^{CLIENT}, in order to compute a Dynamic password or one time password (OTP). It should be appreciated that in accordance with an alternative embodiment of the present invention, a sequential system may be used instead a time based system.

Summarily, one embodiment of this method comprises several steps as follows:
The Client communicates to the server, the client's open, constant and non-secure identification that identifies the entity that the client purports to be, Id^{CLIENT}
The Client computes the result of the function F^{CLIENT} of the time and transmits the Result (OTP) to the Server.
The Server receives the results (Received Results=OTP). As the Server has information as to the entity that the entrant entity purports to be (Id^{CLIENT}) and the Function of the time selected for such entity F^{CLIENT}, the Server may, in principle, compute the result of the function F^{CLIENT} of the time, obtain the result F(time)=OTP which is referred as Computed Result and compare it with the Received Result. The Server may then determine, if identical, that the entrant entity is indeed the True-Client.

But, as explained above, due to the occurrence of DRIFT, the time used by the client, even though the client is the True-Client, is not the Exact Time (ET), but rather the CT^{CLIENT}. Therefore, in many cases, the Received Result will be different than the Computed Result, resulting in a False Rejection of the Client authenticity by the server.

Thus, the above described method may be adapted to reflect this situation; that is, to the situation where there is the presence of the DRIFT.

Therefore, in accordance with another embodiment of the present invention, a method if provided for as follows:
The Client communicates to the server, the client's open, constant and non-secure identification that identifies the entity that the client purports to be, Id^{CLIENT}
The Client sends to the server a synchronization signal for the event.
The Server computes the presumed CT^{CLIENT}(event Time).
The Client computes the result of the function F^{CLIENT} for the CT^{CLIENT}(event Time) F (CT^{CLIENT}(event Time))=OTP and the Client transmits the result to the Server.
The Server receives the results (Received Results=OTP). As the Server has information as to the entity that the entrant entity purports to be (Id^{CLIENT}), the Server also has information as to the shared secret between both entities, which is the Function of the time. Thus, the Server may compute the result of the function F^{CLIENT} on the computed CT^{CLIENT}(event Time), and obtain the computed result F(CT^{CLIENT}(event Time))=OTP (computed), which is referred to as Computed Result. The Server may compare the Computed Result with the Received Result, and determine, if identical, that the entrant entity is indeed the True-Client.

### BRIEF DESCRIPTION OF THE DRAWINGS

A more complete understanding of the present invention may be derived by referring to the detailed description and claims when considered in connection with the drawing Figures, where like reference numbers refer to similar elements throughout the Figures, and:

FIG. 1 illustrates the plane Driftₙ vs Elapsed_Time and the Central Point in accordance with an embodiment of the present invention;

FIG. 2 illustrates the Central line in accordance with an embodiment of the present invention;

FIG. 3 illustrates the line Driftₙ=Drift^{M-E} in accordance with an embodiment of the present invention;

FIG. 4 illustrates the line Driftₙ=Un-Acceptable Drift in accordance with an embodiment of the present invention;

FIG. 5 illustrates the line Elapsed_Time=Elapsed_Time^{M-E} in accordance with an embodiment of the present invention;

FIG. 6 illustrates the Automatic Plesiochonous Area #1 in accordance with an embodiment of the present invention;

FIG. 7 illustrates the Automatic Plesiochonous Area #2 in accordance with an embodiment of the present invention;

FIG. 8 illustrates the Automatic Re-Send Area #1 in accordance with an embodiment of the present invention;

FIG. 9 illustrates the Automatic Re-Send Area #2 in accordance with an embodiment of the present invention; and

FIG. 10 illustrates the Rejection Area in accordance with an embodiment of the present invention.

### DETAILED DESCRIPTION OF THE INVENTION

The present invention may be described herein in terms of various components and processing steps. It should be appreciated that such components and steps may be realized by any number of hardware and software components configured to perform the specified functions. For example, the present invention may employ various electronic control devices, visual display devices, input terminals and the like, which may carry out a variety of functions under the control of one or more control systems, microprocessors or other control devices. In addition, the present invention may be practiced in any number of mobile devices and/or various embodiments of software applications.

As stated above there is a need for a method to synchronize or plesiochronize a Server device with a Client device's clock, when both devices have independent clocks. Further, there is also a need for a method for maintaining information in the server that enables the Server to compute the Computed Time for a multitude of Client devices, each of which may have an independent clock. The Computed Time of Client n, CTₙ^{Client} at one particular instant t, is the time computed by the clock of such client n at such instant t. It should be appreciated that the Computed Time is affected by the specific clock's drift, wherein the clock is affected by the aggregate of specific circumstances (e.g., temperature history, humidity history, power history, etc).

In accordance with one embodiment of the present invention, a method is provided on a system that comprises a plurality of one-time-password (OTP) generators (i.e., Clients), and an authentication/verification Server.

The accuracy of time based one-time-password generation systems is particularly correlated with the plesiochronization of the Server. While it is possible to manufacture Client devices with high quality clocks in order to reduce the Drift, or alternatively, with Drift Reduction Mechanisms, it should be appreciated that these types of solutions will not be well suited, when migrating to existing, off-the-shelf devices such as cell phones. Reference is made here to software Clients running in cell phones, personal digital assistants (PDAs), personal computers (PCs) or any other type of carry-on or portable personal device, such as wristwatches, pens, disk-on-key, and the like.

One characteristic of off-the-shelf devices is that there is no control over selection of clock quality, and consequently, there is no knowledge about the respective Drift rate. Therefore, to achieve plesiochronization of the software clients by the Server is a very difficult job.

In accordance with an embodiment of the present invention, a method is provided for that achieves plesiochronization, wherein the method includes the following steps:

The operator of the software client communicates to the server, the client's open, constant and non-secure identification that identifies the entity that the client purports to be, Id^{CLIENT}

The software client sends to the server a synchronization signal for the event. In accordance with one aspect of the present invention, the signal may be the last three significant digits of the CTₙ^{Client} (present-event). It should be appreciated that in other embodiments, the signal may comprise a different number of significant digits or may comprise different synchronization information.
The software Client n computes the result of the secret (shared with the Server) function Fₙ^{CLIENT} when applied on the CTₙ^{CLIENT}(present event) Fₙ^{CLIENT} (CT^{CLIENT}(present event))=OTP and transmits such OTP value to the Server.
The Server retrieves information from a database or other data storage, about the last former event, CTₙ^{Client} (last-event), for such client n as well as the corresponding CT^{SERVER} (last-event) of such last event.
The server computes the Client n “approximate” CTₙ^{Client} (present-event), whereby “approximate” CTₙ^{Client} (present-event)=CT^{SERVER} (present-event)−CT^{SERVER} (last-event)+CTₙ^{Client} (last-event)=ELAPSED_TIME+CTₙ^{Client} (last-event), wherein ELAPSED_TIME is defined as ELAPSED_TIME=CT^{SERVER} (present-event)−CT^{SERVER} (last-event).
Now, the Server is able to plesiochronize the Server computation for the Client n by using the Client n synchronization signal. That is, by replacing the last three significant digits of the just computed “approximate” CTₙ^{Client} (present-event) with the last three digits sent by the operator of the Software Client n.

This plesiochronized result may be referred to as the Client n clock plesiochronized time at the time of the present event or “plesiochronized” CTₙ^{Client} (present-event).
The Server may retrieve the shared secret with the client n, Fₙ^{CLIENT} (Time) and apply it to the “plesiochronized” CTₙ^{Client} (present-event), thereby obtaining the OTP (computed).
The server may compare the OTP (computed) with the received OTP, and determine, if the computed OTP and the received OTP are identical, that the entrant entity is indeed the True-Client.

But such conclusion may be erroneous as will be shown herein below.

Stated another way, the procedure, as described above, may be modified as set forth below.

In accordance with an embodiment of the present invention, a Drift Restriction method may be applied as set forth below.

It should be appreciated that such a Drift Restriction method is necessary in order to prevent fraud or disruption of the OTP system.

In accordance with this embodiment of the present invention, a simple criterion, referred to as Elemental Criterion, may be such that the Drift of the Client n as computed by the Server should be less than one given value, referred to as Maximum Accepted Drift or MAD (i.e., m minutes).

More precisely, the Criteria may be DRIFTₙ (ELAPSED_TIME)=“plesiochronized” CTₙ^{Client} (present-event)−“approximate” CTₙ^{Client} (present-event)<MAD.

But this simple Criterion alone will not work for the following reasons:

1. If m is wide, the method will enable scenarios such as:

1.1. If the OTP was not transferred to the Server at the OTP's creation time, but later, for example, thirty minutes later, the action may then disrupt the plesiochronization of the next events. This is because for the next event, the last event, which was moved in the time axis, will not be well positioned.

1.2. Further, this procedure as described above with this simple criterion may enable fraud and impersonation. That is, an impostor knowing the Id^{CLIENT}, and having seen a OTP, may after a while, use such information to impersonate the operator of the Client (i.e., the owner of the cellphone where the software client is running).

2. If instead, m is narrow, the server will falsely reject true events coming after a relatively long ELAPSED_TIME between them, for example, if the owner of the cellphone does not use the cellphone as an OTP generator for six months.

(ELAPSED_TIME=6 Months), then the aggregate drift DRIFT (ELAPSED_TIME)=“plesiochronized” CTₙ^{Client} (present-event)−“approximate” CTₙ^{Client} (present-event), will grow with time, as explained above, overcoming the limit MAD of the m minutes.

DRIFTₙ(ELAPSED_TIME)>MAD=m

thus, causing a false rejection. Consequently, it is necessary to create a more sophisticated Drift Restriction method.

Therefore, in accordance with an embodiment of the present invention, the method presented here further provides for the definition and usage of:

a Maximum Expected ELAPSED_TIME=ELAPSED_TIME−(i.e., the 6 months) and a Maximum Expected Drift=DRIFTₙ^{M-E}.

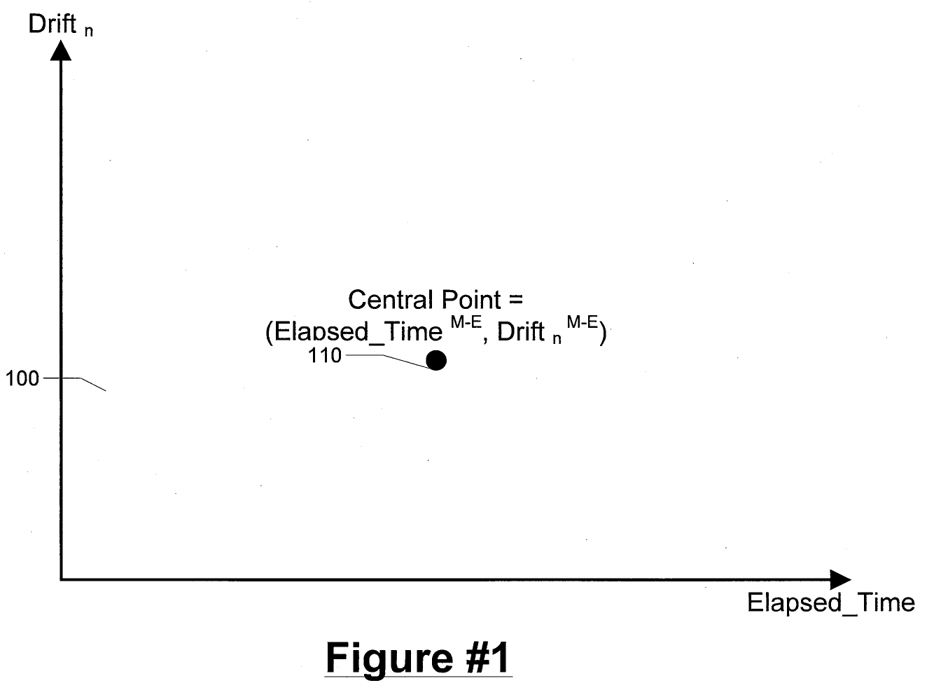

More precisely, with reference to FIG. 1, in the plane DRIFTₙ vs ELAPSED_TIME (100), CENTRAL CRITERIA POINT (110) is defined as (DRIFTₙ^{M-E}, ELAPSED_TIME^{M-E}).

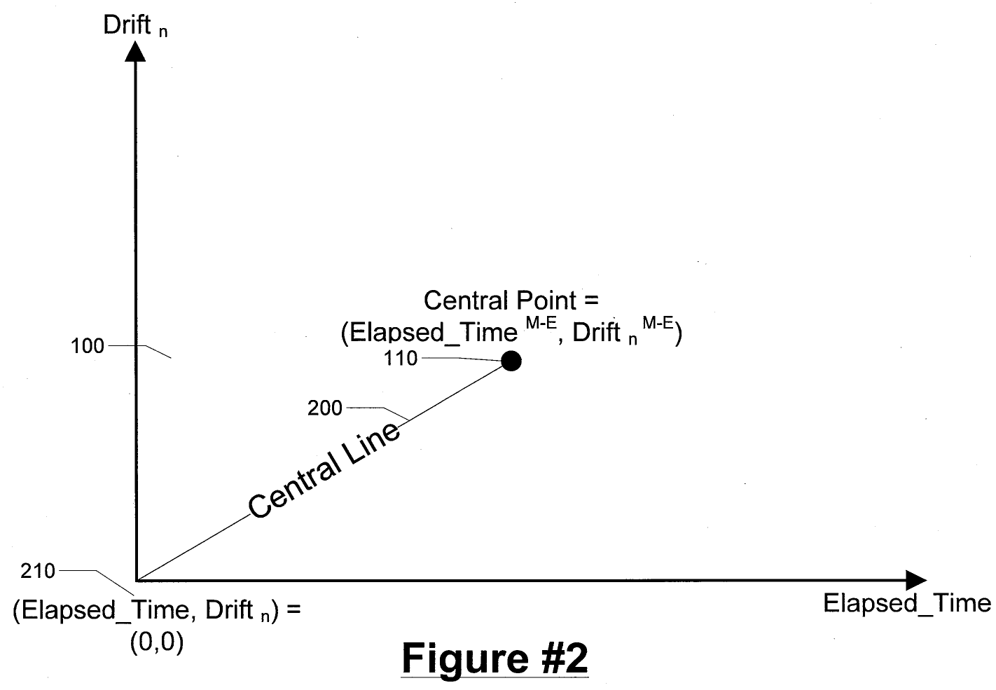

With reference to FIGS. 1 and 2, continuing working with plane (100), due to the fact that for a ELAPSED_TIME=0 it is expected that DRIFTₙ=0, thus (0,0) may be referred to as the Opening Point (210).

Now, a line may be defined which passes through these two points:

the Opening Point (210), and the CENTRAL CRITERIA POINT (110)

DRIFTₙ=(DRIFTₙ^{M-E}/ELAPSED_TIME^{M-E}) X ELAPSED_TIME=A linear function of ELAPSED_TIME referred as f(ELAPSED_TIME)

This line is referred to as the CENTRAL LINE (200).

In accordance with an embodiment of the present invention, the Drift Restriction method includes:
DRC#L

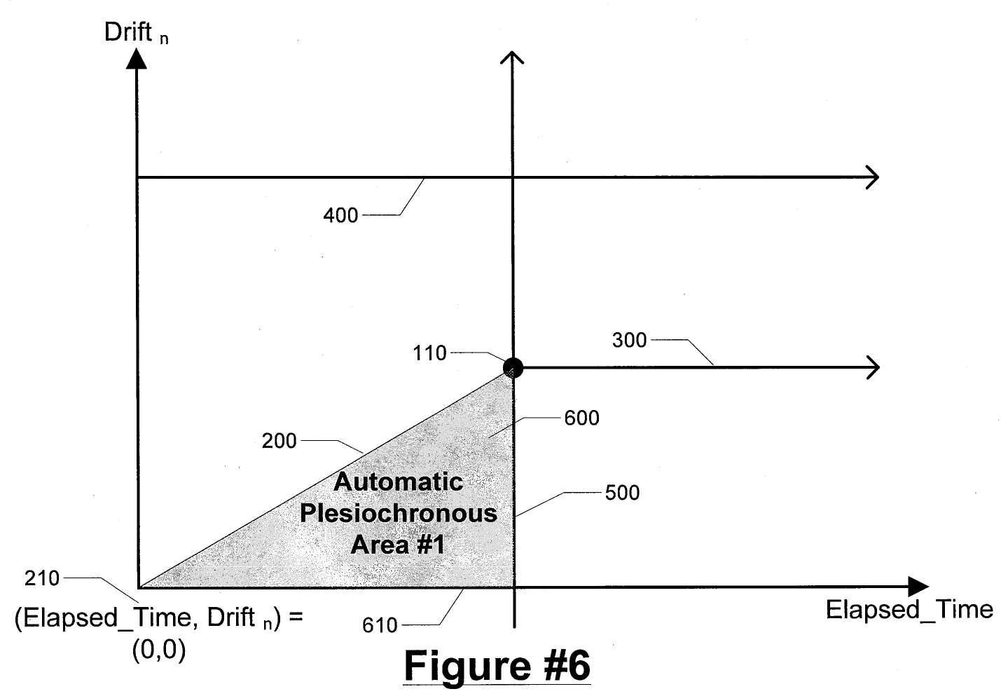

In accordance with an embodiment of the present invention, with reference to FIGS. 2 and 6, if for a given event (i.e., a point in the plane), the ELAPSED_TIME is less than ELAPSED_TIME^{M-E} and the corresponding DRIFTₙ is lower or equal to the f(ELAPSED_TIME), then the event falls within the Automatic Plesiochronous Enabled Area #1 (600). This AREA (600) is delimited by:

a) the axis (DRIFTₙ=0) (610),

b) the CENTRAL LINE (200), and

c) the line ELAPSED_TIME=ELAPSED_TIME^{M-E} (500).

For a point like this, the server will plesiochronize the computed Client clock time and store the values for the next event.
DRC#2

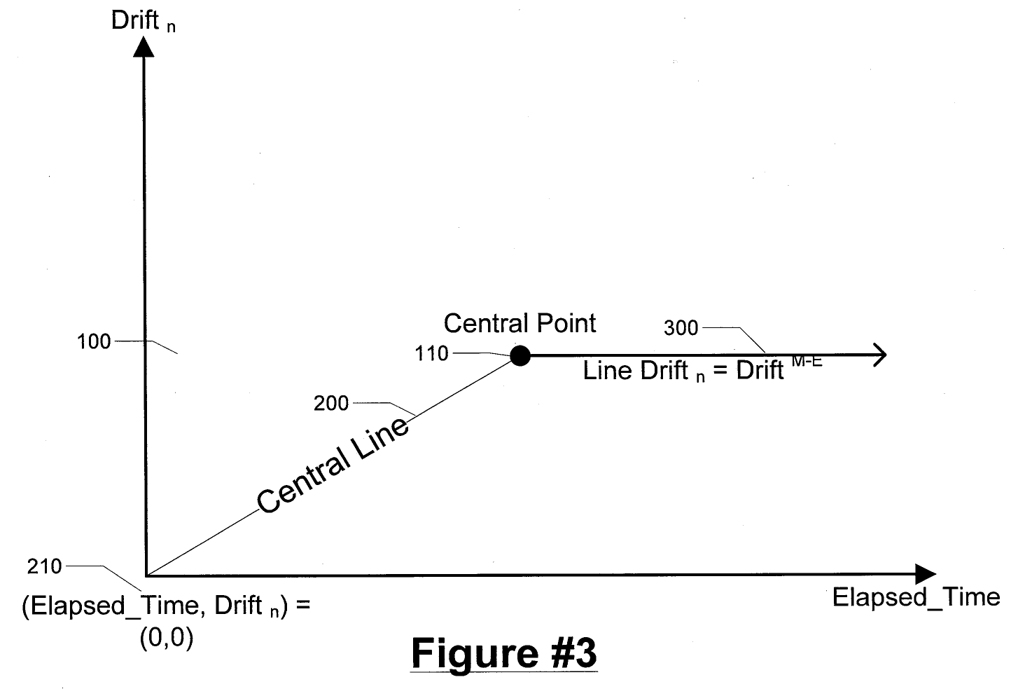

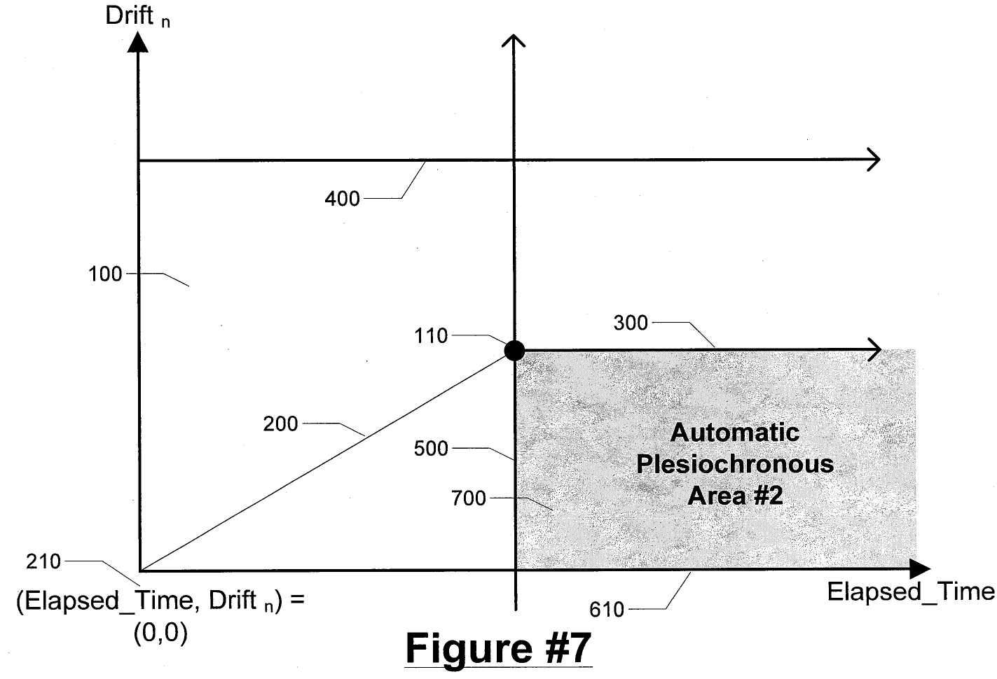

In accordance with an embodiment of the present invention, with reference to FIGS. 3 and 7, if for a given event (i.e., a point in the plane), the ELAPSED_TIME is greater than ELAPSED_TIME^{M-E} and the corresponding DRIFTₙ is lower or equal to DRIFTₙ^{M-E}, then the event falls within the Automatic Plesiochronous Enabled Area #2 (700).

Thus, the Automatic Plesiochronous Enabled Area #2 (700) is delimited by

a) the axis (DRIFTₙ=0) (610),

b) the line ELAPSED_TIME=ELAPSED_TIME^{M-E} (500), and

c) the line DRIFTₙ=DRIFTₙ^{M-E} (300).

For a point like this, the server will plesiochronize the computed Client clock time and store the values for the next event.
DRC#3

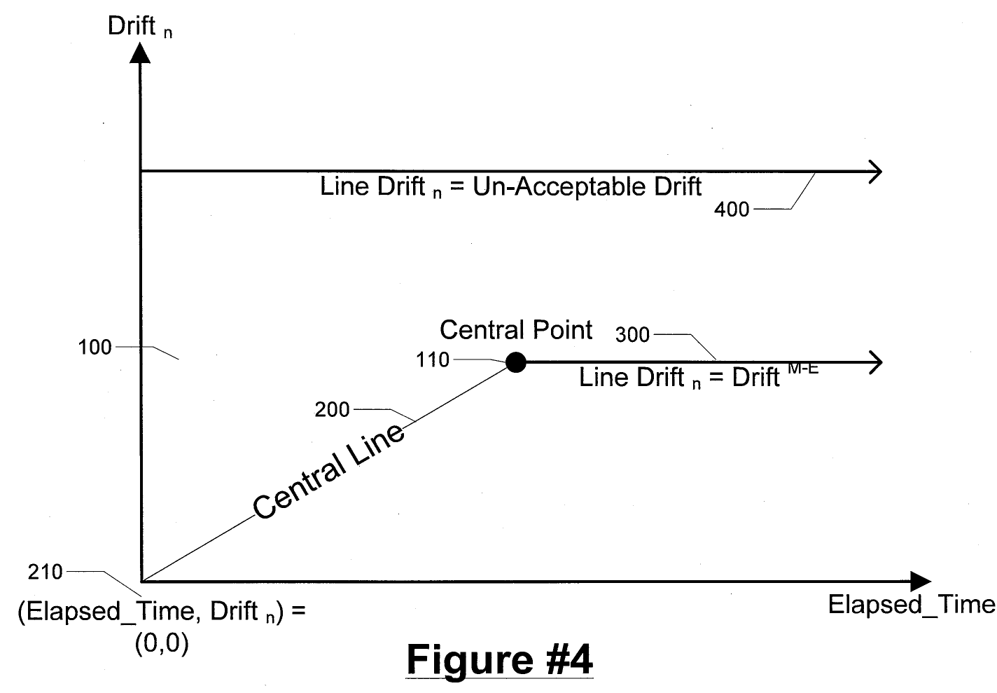

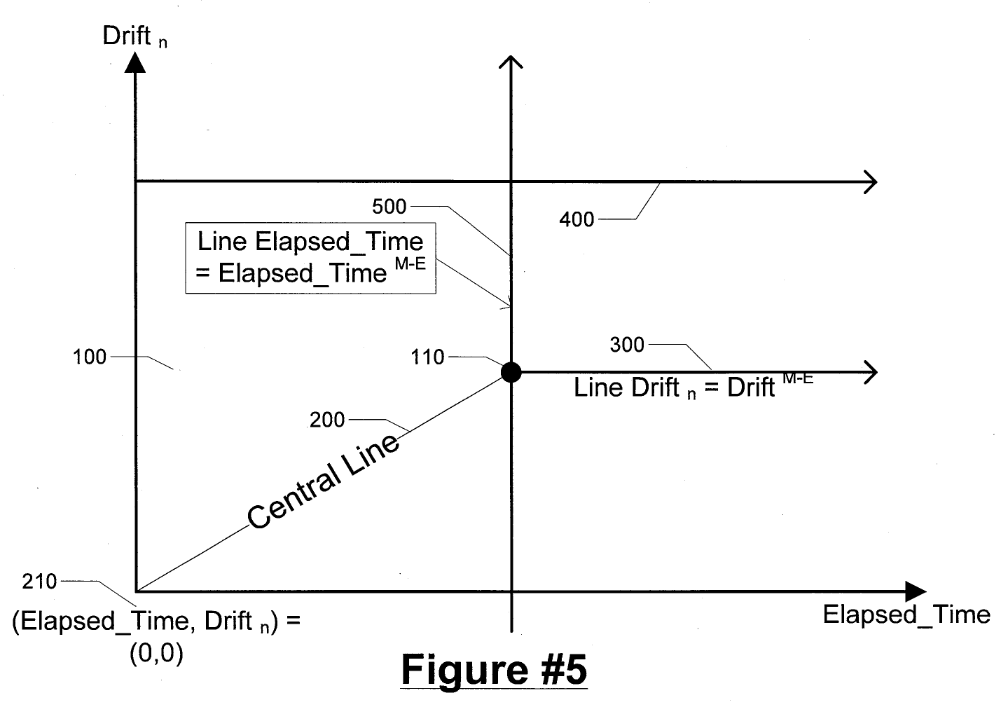

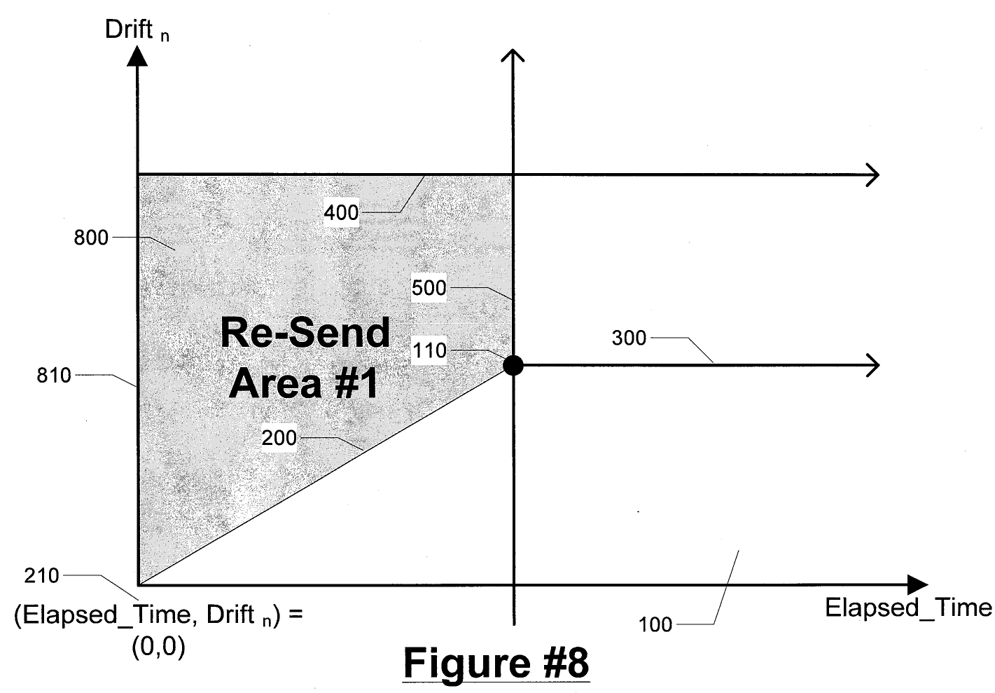

In accordance with an embodiment of the present invention, with reference to FIGS. 4, 5, and 8, if for a given event (i.e., a point in the plane), the ELAPSED_TIME is less than ELAPSED_TIME^{M-E} and the corresponding DRIFTₙ is higher than the f(ELAPSED_TIME), that is, above the CENTRAL LINE (200), but below to a value referred to as UNACCEPTABLE DRIFT (400) (which is necessarily greater than DRIFTₙ^{M-E}), then the event falls within the “Re-Send” Area #1 (800), an area delimited by the following:

a) the line DRIFTₙ=UNACCEPTABLE DRIFT (400),

b) the CENTRAL LINE (200),

c) the axis ELAPSED_TIME=0 (810)

d) the line ELAPSED TIME=ELAPSED_TIME^{M-E} (500)

For a point like this, the server will provisionally store the event parameters and request a new event enabling a random but limited ELAPSED_TIME between them.

Now, since the new ELAPSED_TIME will be very short (usually a few minutes) and the DRIFTₙ must be very low, then the server will plesiochronize the computed Client clock time, using such new event parameters and store the values for the next event.
DRC#4

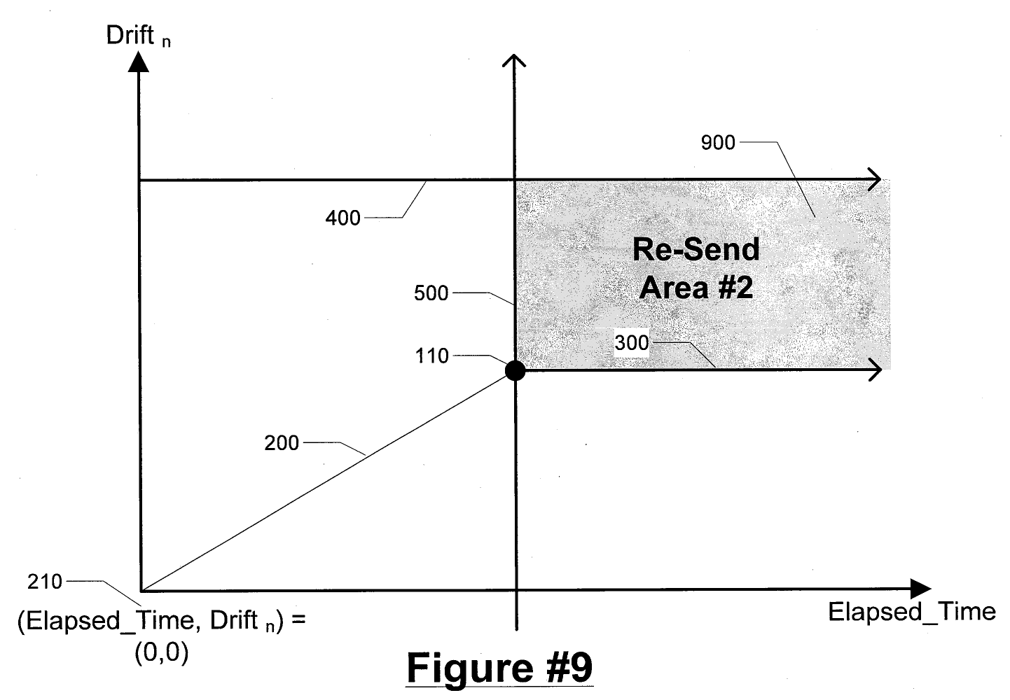

In accordance with an embodiment of the present invention, with reference to FIGS. 3, 4, 5, and 9, if for a given event (i.e., a point in the plane), the ELAPSED_TIME is greater than ELAPSED_TIME^{M-E} and the corresponding DRIFTₙ is higher than the DRIFTₙ^{M-E} a value referred to below as UNACCEPTABLE DRIFT. Thus, the event falls within the Re-Send Area #2 (900).

Therefore, the Re-Send Area #2 (900) is delimited by the following:

a) the line ELAPSED_TIME=ELAPSED_TIME^{M-E} (500),

b) the line DRIFTₙ=UNACCEPTABLE DRIFT (400), and

c) the line DRIFTₙ=DRIFTₙ^{M-E} (300).

For a point like this, the server will request a new event enabling a random ELAPSED_TIME and since the new ELAPSED_TIME will be very short and the DRIFTₙ will be very low, then the server will plesiochronize the computed Client clock time, using such new event and store the values for the next event.
DRC#5

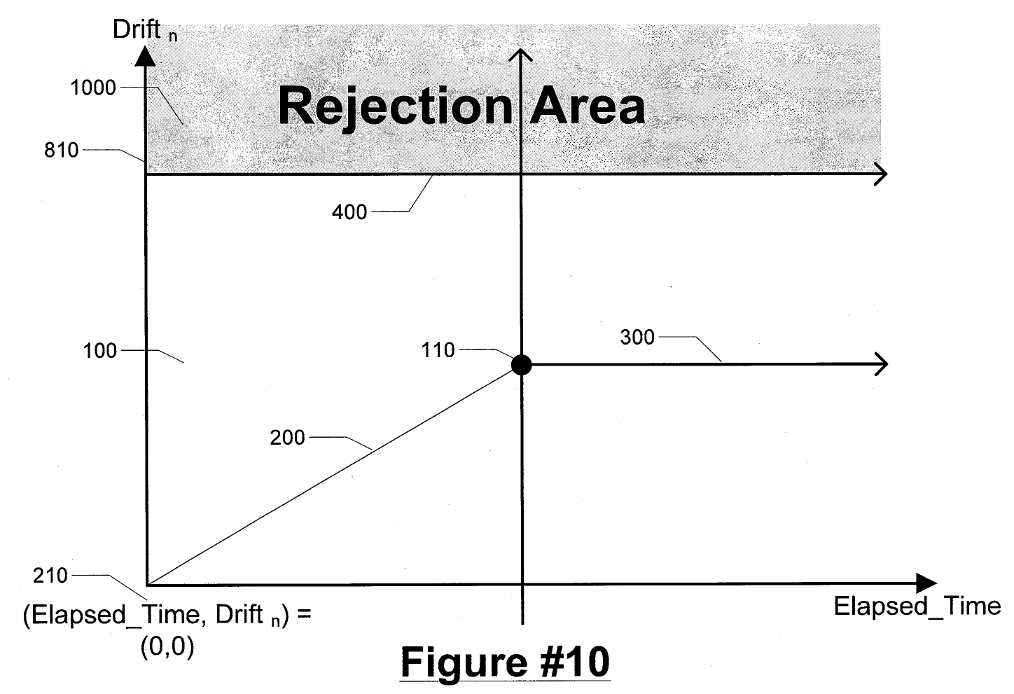

In accordance with an embodiment of the present invention, with reference to FIGS. 4 and 10, if for a given event (i.e., a point in the plane), the ELAPSED_TIME and all the time for the corresponding DRIFTₙ will be higher than the UNACCEPTABLE DRIFT (400), then the event falls within the Automatic Rejection Area (1000).

Therefore, the Automatic Rejection Area (1000) is delimited by the following:

a) the condition DRIFTₙ higher or equal than UNACCEPTABLE DRIFT (400), and

b) the line ELAPSED_TIME=0 (810).

For a point like this the server will reject the event.

Now therefore using the method above described in conjunction with the methods of this invention, the server is able to distinguish between the events in order to prevent disruption, by mistake or due to an attacker, and, perhaps more importantly, in order to prevent fraud due to an intended and potential impostor.

Further, a combination of the Elemental criterion with the Drift Restriction methods, may overcome the non-clock-generated drift, such as the time elapsed by human factors, since the generation of the synchronization signal and the respective transmission to the server, or the delay imposed by network traffic and the like.

Additionally, in accordance with another embodiment of the present invention, the method and Criteria may be further modified taking into account that the Server will reject events felling in the Rejection Area. However, some of such events, all characterized by the fact that the Drift is greater or equal to the Un-Acceptable-Drift, may be caused by Synchronization of the host device's clock due to changes of the time zone.

An example of this case may be the following: a person flying from Europe to USA adjusts the cellphone's clock to the new Time Zone (i.e., USA local time), causing an artificial drift of, for example, five hours. The event will be rejected by the Server.

Nevertheless, adding to the Criteria an additional criterion, referred to as Time-Zone criterion, specific for such category (Rejection Area) of events, wherein the server will adjust its clock time momentarily, in one full hour (plus and minus), and filter the received event again, using the Drift Restriction methods. The event may, this time, be accepted or may fell in the Re-send area. Otherwise, the server will adjust again its clock time momentarily in two full hours (plus or minus) and try to filter the event again. This exercise may be repeated until twelve full hours.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described exemplary embodiments that are known to those of ordinary skill in the art are expressly incorporated herein by reference and are intended to be encompassed by the present claims.

What is claimed is:

1. A method for synchronizing an entity having a clock with a server having a clock, comprising the steps of:
receiving authentication information from the entity, wherein the authentication information comprises dynamic and time based information, and wherein a previous acceptable authentication information has been received from the entity;
using the elapsed time between the reception time of the authentication information and the reception time of the previous acceptable authentication information to establish a plurality of zones for a drift between the entity's clock and the server's clock, wherein the plurality of zones comprises at least a first zone with an upper limit of a maximum drift value and a second zone with a rejection drift range zone;
accepting the authentication information, if an event has a drift falling in the first zone; and
rejecting the authentication information, if the event has a drift falling in the second zone.

2. The method of claim 1, wherein the plurality of zones further comprises a third zone in between the first zone and the second zone, and wherein the method further comprises the step of requesting additional authentication information from the entity, if the event has a drift falling in the third zone.

3. The method of claim 2, further comprising the step of waiting a randomly selected period of time before requesting additional authentication information from the entity.

4. The method of claim 2, wherein if the event has a drift falling in the third zone, further comprising the steps of:
storing the event parameters temporarily;
receiving the additional authentication information from the entity; and
applying the event parameters to the received additional authentication information.

5. A method for synchronizing a plurality of entities, each entity having a clock, with a server having a clock, comprising the steps of:
receiving authentication information from a given entity, wherein the authentication information comprises dynamic and time based information, and wherein a previous acceptable authentication information has been received from the given entity;
using the elapsed time between the reception time of the authentication information and the reception time of the previous acceptable authentication information to establish a plurality of zones for a drift between the given entity's clock and the server's clock, wherein the plurality of zones comprises a first zone with an upper limit of a maximum drift value and a second zone with a rejection drift range zone;
accepting the authentication information, if an event has a drift falling in the first zone; and
rejecting the authentication information, if the event has a drift falling in the second zone.

6. The method of claim 5, wherein the plurality of zones further comprises a third zone in between the first zone and the second zone, and wherein the method further comprises the step of requesting additional authentication information from the given entity, if the event has a drift falling in the third zone.

7. The method of claim 6, further comprising the step of waiting a randomly selected period of time before requesting additional authentication information from the given entity.

8. The method of claim 6, wherein if the event has a drift falling in the third zone, further comprising the steps of:
storing the event parameters temporarily;
receiving the additional authentication information from the given entity; and
applying the event parameters to the received additional authentication information.

9. A method for synchronizing an entity having a clock with a server having a clock, comprising the steps of:
receiving authentication information from the entity, wherein the authentication information comprises dynamic and time based information;
receiving a synchronization signal from the entity;
computing, by the server, the exact entity time for an event, wherein the exact entity time is the event time used by the entity to compute the authentication information, and wherein a previous acceptable authentication information has been received from the entity;
using the elapsed time between the reception time of the authentication information and the reception time of the previous acceptable authentication information to establish a plurality of zones for a drift between the entity's clock and the server's clock, wherein the plurality of zones comprises at least a first zone with an upper limit of a maximum drift value and a second zone with a rejection drift range zone;
accepting the authentication information, if the event has a drift falling in the first zone; and
rejecting the authentication information, if the event has a drift falling in the second zone.

10. A method for synchronizing an entity having a clock with a server having a clock, comprising the steps of:
receiving authentication information from the entity, wherein the authentication information comprises dynamic and time based information;
receiving a synchronization signal from the entity;
computing, by the server, the exact entity time for an event, wherein the exact entity time is the event time used by the entity to compute the authentication information, and wherein a previous acceptable authentication information has been received from the entity;
using the elapsed time between the reception time of the authentication information and the reception time of the previous acceptable authentication information to establish a plurality of zones for a drift between the entity's clock and the server's clock, wherein the plurality of zones comprises at least a first zone with an upper limit of a maximum drift value and a second zone with a rejection drift range zone;
accepting the authentication information, if the event has a drift falling in the first zone; and
rejecting the authentication information, if the event has a drift falling in the second zone and wherein the first zone takes into account non-clock-generated drift such as a human mistakes or a network delay.
